(19) United States
(12) Patent Application Publication
(10) Pub. No.: US 2024/0294221 A1
(43) Pub. Date: Sep. 5, 2024

(54) Leg and Foot Configuration for Spring-Free Legged Locomotion

(71) Applicant: Agility Robotics, Inc., Pittsburgh, PA (US)

(72) Inventors: Jonathan Hurst, Albany, OR (US); Mitchell Bernards, Lake Oswego, OR (US); Andrew Abate, Corvallis, OR (US)

(73) Assignee: Agility Robotics, Inc., Pittsburgh, PA (US)

(21) Appl. No.: 18/575,835

(22) PCT Filed: Jun. 30, 2021
(86) PCT No.: PCT/US2021/040006

§ 371 Date: Dec. 30, 2023

(51) Int. Cl. B62D 57/032

(52) U.S. Cl. CPC B62D 57/032

(57) ABSTRACT

A legged robot has legs that have multiple links, one of which is a distal link. A foot assembly for interacting with the terrain is disposed on a distal end of the distal link. As a robot takes a step, a portion of the foot assembly that has lower effective inertia than the rest of the foot assembly touches down first and acts to reduce the vertical velocity of the rest of the foot assembly before it reaches the terrain through the use of an actuator located on the distal or intermediate link.

### FIELD OF THE INVENTION

This is an international application that discloses subject matter relating generally to apparatus, methods, and systems for autonomous robots and vehicles. More specifically, the disclosed subject matter relates to methods and systems that enable improved autonomous legged locomotion with a light-touch-down foot assembly.

### BACKGROUND OF THE INVENTION

Legged robots typically move in ways that are quite different from animals. In part, this difference is due to the different actuation and materials used; typical robotic actuators have very high reflected inertia, which can cause large impact forces that threaten damage to the robot's components and can destabilize the movement of the robot. Animals achieve fast ground contact with minimal impact forces through the use of physical compliance in tendons, foot flexure, fat pads, and other mechanisms. While a spring-mass solution has been demonstrated successfully in robotic systems (Raibert robots, Bowgo, ATRIAS, ARL Monopod II, and others), control is a major problem when mechanical compliance is a significant feature in the design of a robot. These robots tend to be able to walk and run, enabled by their hardware, but are less able to do more general tasks due to the difficulty of controlling spring behavior within the system.

Most humanoid robots (Asimo, HRP-2, many others) that have the specific goal to do a range of tasks, and to enable control generally, do not include physical springs. As a consequence of the lack of springs and the large inertia of geared electric motors, these robots must very carefully place feet on the ground at near-zero velocity to avoid the possibility of a sudden force being applied to their constituent parts. These robots must have a good estimate of the ground surface location to place the foot carefully, and so tend to be very sensitive to small errors in this estimate.

Some robots use compliant materials on the feet as well as force-sensing electronics to estimate ground reaction forces, and enable control of ground reaction force through the geared motors. These methods suffer from the drawback of bandwidth limitations on force control during impact, or during stance, sometimes oscillating in the force feedback control.

What is needed is a leg and foot design that has minimal mechanical compliance, but that also minimizes the forces caused at impact, protecting robot components from sudden impact forces during ambulation while enabling fine control for a wide variety of tasks.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The disclosed subject matter relates to a legged robot for traversing a terrain having a body and at least two legs, each leg comprising a plurality of links connected in end to end fashion, the plurality of links comprising at least a proximal link and a distal link. The proximal link has a first end rotatably connected to the body and a second end distal from the body. The robot further has a foot assembly, rotatably disposed on a distal end of the distal link of each leg, the foot assembly comprising at least a first foot portion and a second foot portion for making contact with the terrain and generally supporting the robot as it walks. The robot also has a first leg actuator, disposed on one of the body and the first link, configured to rotate the proximal link about the first end. A second leg actuator is also disposed on the proximal link and is configured to rotate an adjacent link relative to the first link. This second leg actuator extends and retracts the leg along a leg length direction. The robot further has a first foot actuator mounted on one of the links that is operable upon the foot assembly wherein contact by the first foot portion with the terrain, when the robot takes a step, causes the first foot actuator to engage and reduce the vertical velocity of the distal end of the distal link to substantially zero just as the second foot portion initially touches the terrain. When functioning as intended, the distal end of the distal link has zero vertical velocity after the second foot portion reaches the terrain and one or more of the first foot portion and the second foot portion remains securely in contact with the terrain during the remaining portion of the step.

In some embodiments, the legs have two links and in other embodiments, they have three links. In the three link configuration, the distal link has a non-compliant extension that extends a distance beyond its rotatable connection point with the intermediate link and further has a connecting rod connecting the proximal link with the extension to establish a four bar linkage comprising the proximal link, the intermediate link, the extension, and the connecting rod.

A first foot actuator is disposed on either the intermediate or distal link and connects too the foot assembly with a connecting rod. In some embodiments, a complaint element is in series between the ground and the first foot actuator, such as a compliant material disposed on a bottom surface of one or more of the first foot portion and the second foot portion. Optionally, the compliant material is engineered to have regions of greater or lesser compliance.

In other embodiments, the foot assembly employs a third foot portion as part of the foot assembly that is rotatably disposed on the first portion, such as with a torsional spring, whereby contact of the third portion with the terrain activates the spring to reduce the vertical velocity of the first portion prior to it reaching the terrain. In this embodiment, the third foot portion effective inertia would be significantly less than the first foot portion and the first foot portion effective inertia would be significantly less than the second foot portion.

The disclosed subject matter further relates to a method of managing forces experienced by a legged robot when taking a step on a terrain. The method includes providing a leg having a distal end and a foot assembly pivotally attached to the distal end, the foot assembly comprising a first foot portion and a second foot portion, the first foot portion having a lower effective inertia than the second foot portion. Then, controlling the approach of the foot assembly as it nears the terrain during the step. Next, contacting the terrain with the first foot portion and reducing the vertical velocity relative to the terrain of the second foot portion, and finally, contacting the terrain with the second foot portion.

In certain embodiments, the disclosed method further includes maintaining contact between the foot assembly and the terrain to enable control of forces applied to the terrain through the remaining portion of the step after touching down.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

The accompanying drawings, which are incorporated in and form a part of the specification, illustrate the embodiments of the invention and, together with the written description, serve to explain the principles, characteristics, and features of the invention. In the drawings:

FIG. 1 is a perspective view of a prior art legged robot.

FIG. 2 is an embodiment of the legged robot that has been modified in accordance with the disclosed subject matter.

FIG. 3 is an illustration of a robot leg constructed in accordance with certain embodiments of the disclosed subject matter in a contracted configuration.

FIG. 4 is another illustration of the robot leg shown in FIG. 3 in an expanded configuration.

FIG. 5 is an illustration of another embodiment of a robot leg constructed in accordance with certain embodiments of the disclosed subject matter in a contracted configuration.

FIG. 6 is another illustration of the robot leg shown in FIG. 8 in an expanded configuration.

FIGS. 7-9 illustrate a foot assembly for use with the embodiments of the robot legs shown in FIGS. 2-6.

FIG. 10 is a flow chart describing a method of operating a foot assembly that can be used with the embodiments of the robot legs shown in FIGS. 2-6.

While implementation of the disclosed inventions are described herein by way of example, those skilled in the art will recognized that they are not limited to the embodiments or drawings described. It should be understood that the drawings and detailed description thereto are not intended to limit implementations to the particular form disclosed, but on the contrary, the intention is to cover all modifications, equivalents, and alternatives falling within the spirit and scope as defined by the appended claims. The headings used herein are not meant to be used to limit the scope of the description or the claims.

### DETAILED DESCRIPTION OF THE INVENTION

The following detailed description includes the best currently contemplated modes of carrying out exemplary embodiments of the invention. The description is not to be taken in a limiting sense, but is made merely for the purpose of illustrating the general principles of the invention.

In the following description, for purposes of explanation, numerous specific details are set forth in order to provide a thorough understanding of example embodiments. It will be evident to one skilled in the art, however, that embodiments can be practiced without these specific details. In some instances, well-known methods or components have not been described in detail so that the details of the present invention are not obfuscated.

In the interest of clarity, some routine features of the implementations described herein are omitted. It will be appreciated that in the development of any actual implementation of the present invention, certain decisions must be made in order to achieve specific goals, and that different decisions can be made to achieve different goals without departing from the teachings of the invention. While certain implementations might be complex and time-consuming, they would nevertheless be routine to accomplish for those of ordinary skill in the art having the benefit of this disclosure.

The disclosed subject matter is directed to a robot leg and foot configuration for legged robots. Specifically, the disclosed subject matter relates to a leg and foot configuration that includes a leg formed from a multi-link elongated assembly and a light-touch foot assembly that eliminates the need for added compliance in the leg mechanism. Some features of the multi-link elongated leg assembly are disclosed in U.S. Pat. No. 10,189,519 to Hurst et al.

The substantial features of the light-touch foot assembly are disclosed in PCT Patent Publication No. WO 2020/176542 to Hurst et al., however, the combination of the leg assembly disclosed herein with the foot assembly unexpectedly permits the elimination of springs from a two- or three-link leg assembly. The resulting combination can isolate mass and inertia from ground impacts in a more desirable and controllable manner. The entire disclosures of U.S. Pat. No. 10,189,519 and PCT Patent Publication No. WO 2020/176542, except for any definitions, disclaimers, disavowals, and inconsistencies, are incorporated herein by reference.

The disclosed subject matter can be directed to a leg and foot configuration for legged robots that provides excellent control through the use of electric actuators, while also enabling human-scale dynamic motions and very quiet, low-impact steps. The disclosed subject matter addresses initial impact forces, while enabling the robot controller to apply forces accurately through the rest of stance.

The disclosed robot has the ability to make a two-stage (or more) contact with the ground, enabling a very low-force initial contact by distal components of the leg, which are connected to small actuators or compliant elements that apply some forces before bottoming out, with subsequent components engaging with the ground and applying larger and larger forces to support the robot's body mass. In some embodiments, the reaction torque from the two-stage impact works with the linear force of the impact to begin accelerating the leg itself, to more readily bend a knee for example.

In some embodiments, a first foot portion touches down on the terrain, such as a heel in certain embodiments. A foot actuator having small effective inertia is connected to the foot assembly, keeping impact forces due to the collision of the first foot portion with the terrain to a minimum. Then, the foot actuator applies torque to reduce the velocity of a second foot portion, such as the mid-foot or toe in some embodiments, until it lands on the ground at zero velocity, engaging the foot rigidly and securely with the ground. Through this action, the effective inertia of the leg and leg actuators are accelerated to match ground speed during the descent of the mid-foot and/or toe, lengthening the time and minimizing the peak forces required to do so. Because the touch-down is gradual, no spring or compliant elements are needed in the leg to protect the larger actuators and electronics higher up in the leg or in the body from the high forces that can be caused by uncontrolled touchdown.

As the step proceeds beyond touch-down, the forces between the ground and the robot legs and body are controlled by larger leg actuators. Then, the robot may utilize very low-friction, high-efficiency connecting rods, in a leg configuration that provides a desirable gear ratio or lever arm, to translate torques from electric motors to foot forces as precisely as possible. The torque from an electric motor is precisely controlled through electronic control of the current in the windings, and if a connecting rod from motor to foot (including all linkages and bearings and gear reductions) can be perfectly efficient, or if a sensor can provide feedback control at the actuator level, or if a very good transmission model enables a compensatory feed-forward control, then the torque at the toe is also precisely controlled.

The reflected inertia of the foot actuator that counteracts the first foot portion striking the terrain will likely cause a small impact torque at a particular link where the actuator is mounted. In some embodiments, a first link, closest to the robot body, can be thought of as representing the thigh, the second link the shin, and the third distal link the tarsus. Typically, a classic four-bar arrangement is used in conjunction with the links below the first link. A foot with a heel and a toe can be rotatably connected at the distal end of the third link of the leg. In some embodiments, such as where the toe touches down first, it is preferred to have at least one foot actuator mounted on the third link. In certain other embodiments, such as where the heel touches down first during a step, an additional reduction in impact can be achieved by mounting the foot actuator on the second link. In such embodiments, the impact reaction torque experienced at the second link can cause the leg to retract in a manner that cooperates with the linear direction of the impact force.

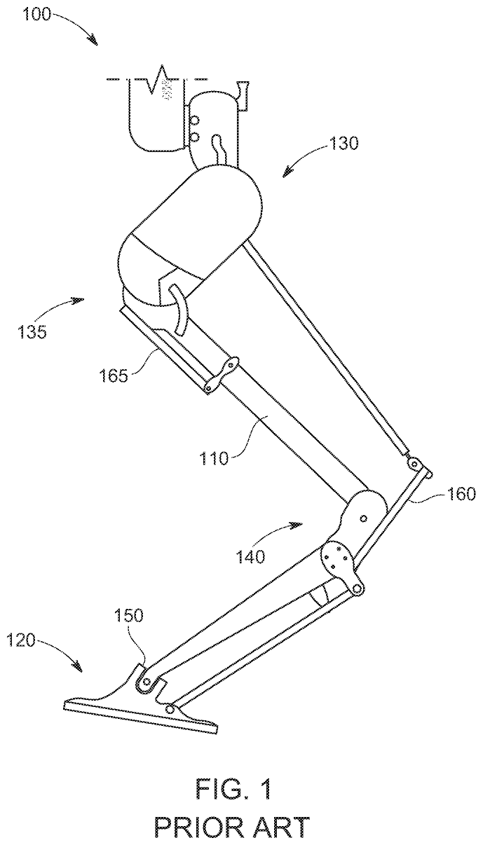

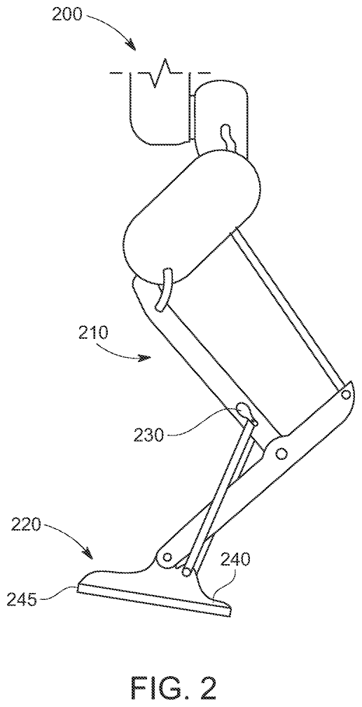

Now referring to FIGS. 1-2, a leg 110 of a legged robot, such as the prior art legged robot 100 is illustrated. Although only one leg is illustrated, these robots 100 have at least two extendable legs 110 that each terminate in a foot assembly 120. In order to take a step, actuators in the hip 130 and the knee 135 coordinate to cause the legs 110 to lift off the walking surface, move forward, and descend to the walking surface again. Actuators in the ankle 140 control movement about the toe joint 150 that connects the feet 120 to the legs 110. Notably, robot 100 has a first spring 160 and a second spring 165 (hidden inside the leg) to protect actuators 130, 135 from sudden force spikes caused by the feet touching down on the ground during the act of walking. However, it is desired to remove the springs 160 and 165 for additional control. In addition, although the springs help to reduce impact forces, there still remains significant inertia of the leg between the springs and the foot which contacts the ground, leading to undesirably “stompy” gaits, and larger-than-desired impact forces. As used herein, leg inertia is defined as all of the mass of a leg that changes velocity when the foot touches the ground as part of taking a step, including any reflected inertia of actuators that are operationally connected to the leg.

Referring now to FIG. 2 with continuing reference to the foregoing figure, a modified version of the robot 100 of FIG. 1 is shown as the robot 200. The robot 200 is modified in accordance with the disclosed subject matter by implementing a multiple-stage approach to handle the initial impact when a modified three-link leg 210 and foot assembly 220 contacts the ground. The foot assembly 220 touches down with a very low effective inertia, initially. Then, foot assembly actuators 230 positioned on the leg 210 gradually decelerate the remainder of the foot assembly 220 until its velocity matches the speed of the ground.

Additional modifications to the robot 200 can include a modification to the foot assembly 120 shown in FIG. 1. In embodiments, the modified foot assembly 220 includes a first portion 240 that impacts the ground before the weight of the robot 200 is supported by the foot assembly 220 during a step. As the first portion 220 makes contact with the ground, at least one passive element, such as a spring, or an active element such as an actuator, or a combination of active and passive elements acting in series, whether backdriven or otherwise controlled, cause a second portion 245 of the foot assembly 220 to reduce velocity until it reaches substantially zero velocity, which preferably occurs at the same moment that the second portion 245 touches the ground. Substantially zero velocity at contact ensures ground speed matching which prevents a rigid body collision with any of the elements that make up the leg inertia. Zero acceleration ensures equalized forces above and below the foot at that moment, which means that the second portion does not cause impact forces, cause loud sounds, or inefficiently rebound off the ground in any way.

The modified robot 200 provides compliant contact during impact and rigid contact during stance. Additionally, the robot 200 can have series compliance in the form of toe and heel bumpers or sprung/damped mechanisms when the foot assembly 220 is only in partial contact with the ground. Importantly, there is no series compliance when the foot assembly 220 is in full contact with the ground (i.e., after both portions have touched down). This enables better control authority and the use of standard rigid-body control methods without assumptions. This configuration of the modified robot 200 removes the detriment of impact while, at the same time, permitting well-known control techniques.

In certain embodiments, the effective inertia of the first portion 240 is substantially less than the effective inertia of the leg, which effectively contacts the ground when second portion 245 does. This “effective inertia” is calculated or measured at the point of contact, and includes contributions from at least portions of the rotational inertia of the foot assembly 220, portions of the linear inertia of the foot assembly 220, and portions of the reflected inertia caused by the spinning up of any actuator (such as actuator 230) that is operationally connected to the foot assembly 220.

As the step continues beyond the point where the second portion 245 touches down on the ground, the forces applied to the foot assembly 220 by the leg 160 are increased, holding any passive elements involved with the operation of the foot assembly, such as a foot spring, for example, against its hard stop for those embodiments having such a spring. This “bottoming-out” of the spring in the foot assembly 220 temporarily converts it into a rigid connection between the ground and the leg 160. In this way, the foot assembly 220 has effectively matched the vertical velocity of the leg with the ground, all with a smooth force transition from zero force at contact (before touch-down), smoothly increasing force to the point of full foot contact, such that the leg now controls the forces being applied to the ground, with no collision, force spike, or control issues. To further illustrate this new approach, several exemplary embodiments will be discussed herein.

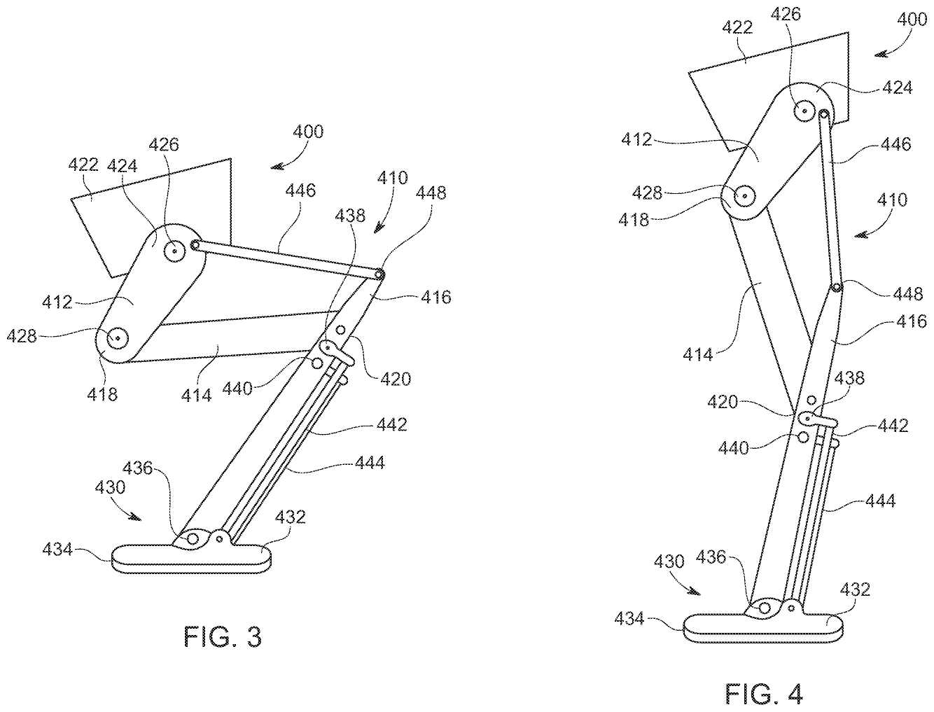

Referring now to FIGS. 3-4 with continuing reference to the foregoing figures, an exemplary robot 400 having an exemplary leg 410 for legged locomotion is illustrated. The leg 410 can include at least first, second, and third links 412, 414, and 416, connected to each other by joints 418,420 and to a body 422 by a joint 424. A hip actuator 426 can be mounted on the robot body 422 for moving the leg 410 forward and backward in relation to the body 422. A knee actuator 428 can be disposed on the first link 412 for extending and retracting the leg 410.

The first link 412 can be pivotally connected to the second link 414. The second link 414 can be pivotally connected to the third link 416. The first link 412 has opposing first and second ends with the first end being pivotally mounted to the body 422. The third link 416 has a distal end (As used herein the term “proximal” refers to a location closest to the robot body 400, while the term “distal” refers to a location relatively further from the robot body 440) having a foot assembly 430 pivotally disposed thereon. In certain embodiments, the second link 414 and the third link 416 have respective longitudinal axes. In such embodiments, the second link 414 and/or third link 416 can be rotatable about their respective longitudinal axes to provide yaw and adduction/abduction of the leg 410.

In certain embodiments, the foot assembly 430 includes a first portion 432 and a second portion 434. The foot assembly 430 further includes a rotational lower ankle joint 436 providing a functional connection point between the leg 410 and the foot assembly 430. In embodiments, the foot assembly 430 is designed and constructed to operate in a two stage manner whereby the first portion 432 touches down first during a step and acts upon the second portion 434 to reduce its velocity to zero as it reaches the ground. Those of skill in the art will recognize that the reverse touch-down process can be enabled in some embodiments wherein second portion 434 touches down first and reduces the velocity of first portion to zero as it reaches the ground as may happen if the robot 400 is walking backwards or if the leg configuration is altered so that the second portion 434 touches down prior to the first portion 432 by design as the robot 400 walks forward.

During a stride, the first portion 432 of the foot assembly 430 contacts the ground first, and when it does, the rotational lower ankle joint 436 employs passive dynamics, such as one or more springs, to reduce the vertical velocity, relative to the terrain, of the second portion 434. In certain other embodiments, one or more foot actuators 438-440 are added or used independently to reduce the vertical velocity of the forwardly-positioned second portion 434 relative to the terrain, substantially reaching zero (or matching the velocity of the terrain) at the point of contact. In certain embodiments, the lower ankle joint 436 employs a combination of both passive and active elements.

The foot actuators 438-440 can be mounted on any of the links 412, 414, or 416 or in the body 422. In certain embodiments, the foot actuators 438-440 are mounted on the third link 416 with connecting rods 442-444 connecting one or more of the foot actuators 438-440 to the first portion 432. In certain embodiments, one of the foot actuators 438-440 is used as described while the other actuator provides additional balancing side-to-side forces when needed.

In some embodiments, the hip actuator 426 can be rotated off-axis to allow the leg 410 to rotate in the yaw direction to turn the robot 400, or to allow adduction/abduction of the leg 420; but for the purposes of the actuation in the sagittal plane (forward/backward) it can be fixed to the body frame of reference. The hip and knee actuators 426-428 and other heavy components can be placed proximate the first link 412 or higher on the leg 400, or mounted on the body 422. Doing so helps in isolating the inertia of the hip and knee actuators 426-428 and other heavy components from ground impact.

As shown in FIGS. 3-4, an embodiment can include a first connecting rod 446 that connects the first link 412 with the third link 416 via extension joint 448 to constrain rotation of the third link 416 about the upper ankle joint 420 in the manner of a four-bar linkage, when the knee actuator 428 moves the second link 414. In this manner, the hip actuator 426 rotates the leg in the sagittal plane of the robot while the knee actuator 428 extends and retracts the leg length.

The hip actuator 426 can be any suitable actuator, such as a motor having a rotary shaft that can be mounted to the body 422 and operated with a suitable connecting rod. In some embodiments, leg actuators 426-428 can include cables and/or transitions, such as pulleys. The leg actuators 426-428 can be configured to rotate and/or control the length of one or more of the links 412-416. In other embodiments, the actuators 426, 428, 440, 438, and others can include ball screws and linkages, providing additional configuration-dependent speed reduction.

Additionally, the hip and knee actuators 426-428 can be arranged such that internal work loops are minimized, thus avoiding the scenario where one of the leg actuators 426-428 does positive work while the other one of the leg actuators 426-428 does negative work, to generate a net positive work output for the robot 400.

In certain embodiments, the robot 400 can be implemented in a bi-pedal configuration with a second leg (not shown) that is substantially identical to the leg 410. In such embodiments, the second leg includes two additional hip and knee actuators that are arranged as a mirror image of the leg 410. In some embodiments, the robot 400 can be implemented with the leg 410 configured as a humanoid leg and the foot assembly 430 functioning as a heelstrike. Additionally, the robot 400 can be implemented in an avian configuration having an avian configured leg 410 and foot assembly 430 functioning as a heelstrike.

The avian configuration provides for a squat posture that allows for easier control. Additionally, the squat posture allows for larger robustness to unexpected ground height changes.

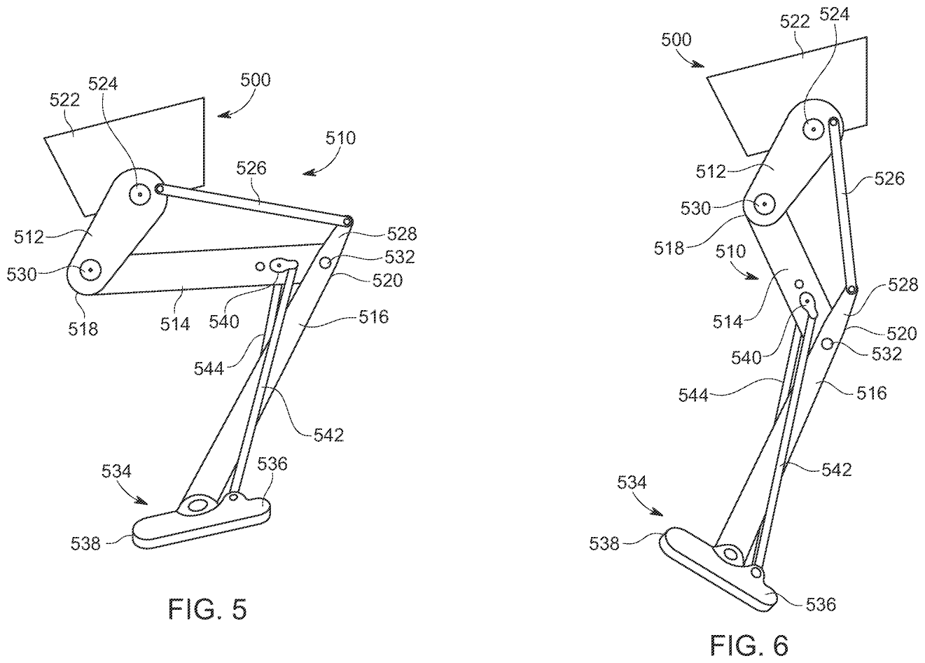

Referring now to FIGS. 5-6 with continuing reference to the foregoing figures, another embodiment of an exemplary robot 500 having an exemplary leg 510 for legged locomotion is shown. Like the embodiment shown in FIGS. 3-4, leg 510 can include at least first, second, and third links 512-516, connected to each other by joints 518-520 and to a body 522. Optionally, the leg 510 can include connecting rod 526 connecting the first link 512 to the third link 516 as was discussed in relation to FIGS. 3-4 . . . .

Like FIGS. 3-4, the robot leg 510 further includes a hip actuator 524 and a knee actuator 530. The first link 512 has opposing first and second ends with the first end being pivotally mounted to the body 522. The third link 516 has a distal end rotatably connected to a foot assembly 534. The foot assembly 534 includes a first portion 536 and a second portion 538. In embodiments, the foot assembly 534 is designed and constructed to operate in a two stage manner, similar to the discussion regarding the embodiment shown in FIG. 2.

Unlike the embodiments shown in FIGS. 3-4, robot leg 510 includes a foot angle actuator 540 that is mounted on the second link 514. This configuration effectively reduces contact inertia at the heel and raises it at the toe. The foot angle actuator 540 connects to the foot assembly first portion 536 with linkages 542-544. In certain embodiments, there are two foot angle actuators on opposing sides of the second link 514 that attach in two different locations on the foot assembly to control pitch and roll movement of the foot assembly 534.

There are two alternative locations for the foot angle actuators that control the two-stage foot assembly landing. In certain embodiments such as illustrated in FIGS. 5-6, the movement of the leg 510 from a contracted configuration to extended configuration causes connecting rod 526 to rotate foot assembly 534 into proper two stage position without any additional actuation, which results in unexpected efficiencies in some embodiments, in the form of reduced contact inertia, above arrangements in which a foot does not rotate with the extension and/or contraction of a leg.

In some embodiments, the disclosed legs 410 of FIGS. 3-4 and/or leg 510 of FIGS. 5-6 can be configured to include one or more 2-axis gimbals and/or motors to allow twist or yaw. Such features are particularly desirable for a legged robot to operate without support, so that the robot can balance side-to-side (in the frontal plane) as well as forward-backward (in the sagittal plane). However, most of the strength and power in walking or running is associated with the sagittal plane motion. As a result, a leg configuration can require large motors associated with the sagittal direction.

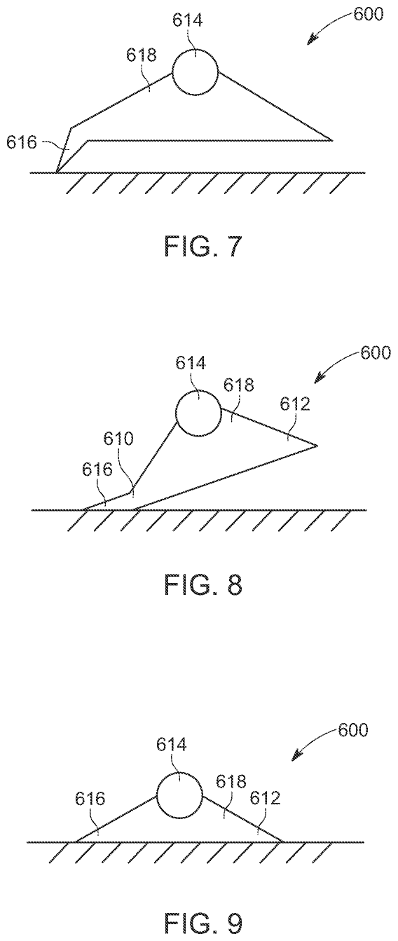

Alternatively, a pair of gimbal actuators can be arranged on the disclosed legs 410 of FIGS. 3-4 and/or leg 510 of FIGS. 5-6 in the manner shown in U.S. Pat. No. 10,189,519 (i.e., FIGS. 7-8 and/or 10A-10B), which represents another approach for implementing adduction/abduction (to balance in the frontal plane) and yaw (to effect steering). One of the actuators can include a motor and transmission, such as a cycloid transmission. Additionally, the robot 400 of FIGS. 3-4 and/or the robot 500 of FIGS. 5-6 can be configured for movement of a leg in the sagittal plane in the manner illustrated in U.S. Pat. No. 10,189,519 (i.e., FIGS. 9A-9D).

FIGS. 7-9 illustrate a time progression of the manner of operation of certain embodiments of a foot assembly 600 that further reduces any impact forces that can be experienced by a robot employing the methods and assemblies disclosed herein. Like previously discussed assemblies for the embodiments shown in FIGS. 3-6, the disclosed foot assembly 600 has a first portion 610 and a second portion 612 wherein the first portion 610 is expected to contact the terrain prior to the second portion 612 and the rotational joint 614 employs one or more of a compliant element and an actuator to impede the rotation of the foot assembly about the rotational joint 614, thereby causing the second portion 612 to contact the terrain just as the vertical velocity of the second portion 612 reaches substantially zero, relative to the terrain.

Unlike the assemblies of previous figures, however, foot assembly 600 has a third portion 616 disposed on or adjacent to the first portion 610. In certain embodiments, the third portion 616 can be constructed of foam, urethane, a polymer, or another material having similar qualities and biased such that touchdown on the terrain or ground will cause it to bend or deform, thus reducing the vertical velocity of the first portion 610 prior to touching down. In embodiments, the third portion 616 can be attached to the first portion 610 or to both first and second portions 610, 612. In other embodiments, the third portion 616 can be constructed of aluminum with a foam or polymer material covering that is attached to first portion 610 via a torsional spring, actuator or back-drivable actuator. In still other embodiments, the third portion 616 can be a foam, urethane, or other polymer coating on the sole of the first portion 610 that provides velocity reduction to the first portion 610. In still further embodiments, third portion 616 as illustrated in FIGS. 7-9 is representative of a compression spring placed in series with the foot assembly in the connecting rod, such as connecting rod 542, 544. In the foregoing embodiments, third portion 616 is the initial component to come into contact with the terrain. Upon contact with the terrain, as illustrated in FIG. 7, the third portion 616 assists with reduction in velocity of first portion 610 prior to first portion 610 touching down on the terrain. In embodiments where the third portion 616 is rotatably connected to first portion 610, third portion 616 is forced upward upon touch down in relation to the first portion 610, causing the torsional spring or other compliant element and/or actuator to engage and reduce the vertical velocity of the first portion 610 so that its vertical velocity at the initial point of contact with the terrain matches terrain velocity, thus preventing sudden impact forces from occurring.

In certain other embodiments, the third portion 616 is constructed with a compliant foam or other material having a linear or non-linear compliance appropriate for the application or configuration of the robot and is bonded or otherwise applied to the first portion 610. Upon contact with the ground or walking surface, the compliant material further decelerates the first portion 610, until it initially contacts the terrain at a matched terrain velocity. In certain embodiments, a metamaterial having a fixed bulk modulus is disposed on the bottom of the foot assembly 600 and has sections of varying size depending on desired stiffness reduction cut out from the material such that the material is more compliant near the front and back edges and stiffer in the middle.

After the rearmost part (i.e., first portion 610) has touched down, the rotational joint 614, having one or both of a spring and an actuator, applies torque to decelerate the rotation of the main support portion 618 about the joint 614 so that the lower leg (i.e. third link 416 shown in FIGS. 3-4 and/or third link 516 shown in FIGS. 5-6), attached at joint 614, and frontmost part (i.e., second portion 612) of the main support portion 618 have zero vertical velocity at the point in time when the main support portion “bottoms out” on the ground, as shown in FIG. 9.

As a result, from the time of initial contact of third portion 616, represented in FIG. 7, through the initial point of contact of the first portion 610 of the foot assembly 600 with the terrain as illustrated in FIG. 8, until the point in time when the second portion 612 contacts the terrain as shown in FIG. 9, there is a smooth ramping of force that counteracts and reduces the vertical velocity of the leg, represented herein by the ankle joint 614, toward the terrain to match the velocity of the terrain at contact, substantially reducing any force associated with such an impact. While typical human heel to toe foot assembly structure for a “heel to toe” gait has been illustrated, it is to be understood that the presently disclosed structure and methods can equally be applied to a “toe-to-heel” gait, such as that exhibited by birds, for example.

Those skilled in the art will recognize that additional embodiments can comprise additional portions and corresponding connectively engaged compliant elements or actuators, with descending effective inertia, to create a force ramp that is as smooth as possible. In certain embodiments, the same functionality can be created with a single shaped structure of nonlinear compliance. This structure can contact the ground with a comparatively soft portion, and as the forces increase during the stride, engage greater and greater surface area of the foot with increasing stiffness of the foot structure, so it behaves as a single nonlinear spring that could be approximated by a multitude of links and springs of increasing stiffness. In further embodiments, a connecting rod, such as a cable or tendon connecting rod, causes an actuator to behave with varying effective inertia and torque as a shaped foot component engages with the ground; acting as a series of increasingly large actuators and links would act. This continuous shifting of compliance and actuator can result in a smoother force ramp than individual links and compliant elements or actuators, while still achieving the function of decelerating the leg mass to ground speed and avoiding any substantial impact forces.

In certain embodiments, where an actuator is employed in the ankle joint 614, it can be oriented so that when the foot assembly 600 first touches the terrain at the first portion 610, the actuator is either activated and operates normally or backdrives to slow the vertical velocity of the second portion 612 until it reaches the terrain. The same principle can apply to the relationship of the third portion 616 to the initial touchdown of the first portion 610. As the stride progresses beyond touch-down, any of the actuators can then operate normally to assist with pushing the robot forward in the latter part of the stride.

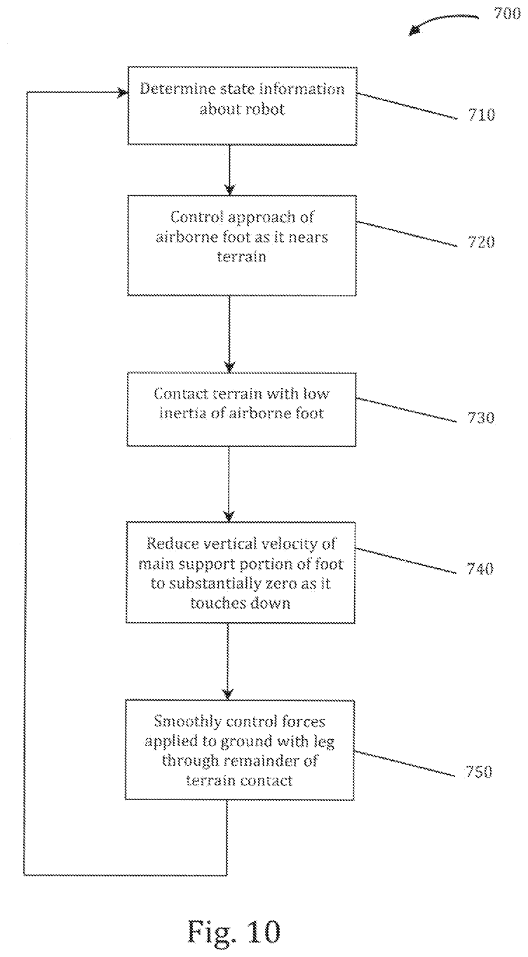

In certain embodiments, such as the method referenced in FIG. 10, the disclosed robot systems employ a method 700 of enabling a legged robot to traverse a terrain, while minimizing the noise and force spikes associated with placing each foot assembly and transferring the weight of the robot to that foot during the act of walking. An embodiment of the method comprises first determining the state of the robot at Step 710. This step includes determining the relative locations and/or positions of all of the limbs of the robot using encoders and other sensors. In certain embodiments, encoders are positioned in every joint so that a robot movement controller knows the relative location of every body part at all times. In embodiments, the orientation of the robot body relative to the ground is also tracked using an angular rate measurement device, such as a gyroscope or an inertial measurement device. These sensors provide information about roll, pitch and yaw of the robot body. Armed with this information, and assuming a first foot is on the ground, it is possible to calculate the relative position of an airborne foot during a stride. This location then becomes part of the state information.

Next, the method involves controlling the approach of the foot assembly as it nears the walking surface at Step 720, so that it is within predetermined parameters at the point of initial ground contact. In certain embodiments, the vertical velocity can be controlled by actuators at the top of the leg in what could be called the hip area or in another joint analogous to a human knee. In embodiments, all encoder and other sensor data is transmitted to a central processor that, in turn, calculates state information and any appropriate future movements and controls the operation of any actuators that are used.

In certain embodiments, the foot has been designed so that a low effective inertia (“first”) portion makes contact with the terrain prior to a main support (“second”) portion. In such embodiments, the next step (i.e., Step 730) is for the low effective inertia (“first”) portion to contact the ground and begin to reduce the vertical velocity of the main support (“second”) portion of the foot at Step 740 prior to it reaching the terrain. In embodiments, the low effective inertia portion is able to act upon the main support portion via a spring and/or actuator and preferably speed match a part of the main support portion with the ground or walking surface as has been discussed herein. Those with skill in the art will recognize that this process can be repeated with additional foot portions having less effective inertia than existing portions and further having mated springs and/or actuators sufficient to control the vertical velocity of the subsequent portions. Further, that a large number of foot portions and compliant elements can be equivalent to a single shaped structure with varying nonlinear compliance, as the engagement with the terrain progresses through the point of initial contact to fixed engagement.

In certain embodiments, as the foot touches the terrain in the next step of the walking method, such as at Step 730, the actual vertical speed with which the foot assembly is approaching the ground can be confirmed by measuring how quickly the low mass portion of the foot moves upon contact with the terrain. If it is determined that the foot assembly is approaching the terrain faster than planned, such as if the robot had been pushed and had to place the foot assembly more quickly than intended to maintain balance, the controller on the relevant actuators could be adjusted in real time to accommodate the unexpected approach velocity and still be able to reduce the velocity to zero at main support portion impact.

In certain embodiments, where a leg is connected to a main support portion of a foot as in FIGS. 10-12, the foot strike can be designed such that the second portion 612 will contact first, rather than the first portion 610. In such an embodiment, an additional element, (i.e., similar to third portion 616), can instead be connected to the second portion 612. The method of the invention can be employed with success in either gait type.

In certain embodiments, the foot assembly 160 of FIG. 2, the foot assembly 430 of FIGS. 3-4, the foot assembly 534 of FIGS. 5-6, and/or the foot assembly 600 of FIGS. 7-9 has at least two separate but connected portions a low effective inertia (or “first”) portion that is designed to make initial contact with the terrain and a main support (or “second”) portion that carries the effective inertia of the leg and foot, such that the second portion must be firmly engaged with the ground during mid-stance. In embodiments, the low effective inertia portion has an effective inertia that is approximately one order of magnitude less than the effective inertia of the main support portion.

Additionally, it should be understood that some of the above-described actuators can be implemented as electric motors with a rotational shaft, such as a brushless linear DC motor. Alternatively, an actuator can comprise a motor that actuates a pulley relative to the robot body. Further, different types of motors could be used-brush motors, brushless motors, stepper motors, frameless motors, axial flux motors, and so on. Any suitable motor technology can be used, but it is preferable in certain embodiments to minimize rotor inertia and motor mass while maximizing torque and power output.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

While specific embodiments of the invention have been described in detail, it should be appreciated by those skilled in the art that various modifications and alterations could be developed in light of the overall teachings of the disclosure. Accordingly, the particular arrangements, apparatuses, systems, and methods disclosed are meant to be illustrative only and not limiting as to the scope of the invention.

We claim:

1. A legged robot for traversing a terrain, comprising:
a robot body;
at least two legs, each leg comprising a plurality of links connected in end to end fashion, the plurality of links comprising at least a proximal link and a distal link, the proximal link having a first end rotatably connected to the body and a second end;
a foot assembly, rotatably disposed on a distal end of the distal link of each leg, the foot assembly comprising a first foot portion and a second foot portion for making contact with the terrain;
a first leg actuator, disposed on one of the body and the first link, configured to rotate the proximal link about the first end;
a second leg actuator, disposed on the proximal link, configured to rotate an adjacent link relative to the first link, wherein the second leg actuator is operable to extend and retract the leg along a leg length direction; and
a first foot actuator mounted on one or more of the links, operable upon the foot assembly wherein contact by the first foot portion with the terrain, when the robot takes a step, causes the first foot actuator to reduce a vertical velocity associated with the distal end of the distal link to substantially zero as the second foot portion initially touches the terrain;
wherein the distal end of the distal link has zero vertical velocity after the second foot portion reaches the terrain and one or more of the first foot portion and the second foot portion remains securely in contact with the terrain during a remaining portion of the step.

2. The legged robot of claim 1, wherein the adjacent link is the distal link.

3. The legged robot of claim 1, wherein the adjacent link is an intermediate link that is rotatably disposed on the second end of the proximal link and extends to a first rotatable connection point on the distal link.

4. The legged robot of claim 3, wherein the distal link comprises an extension that extends a distance beyond the first rotatable connection point, the leg further comprising a connecting rod connecting the proximal link with the extension at the distance to establish a four bar linkage comprising the proximal link, the intermediate link, the extension, and the connecting rod.

5. The legged robot of claim 3, wherein the first foot actuator is disposed on one of the intermediate link and the distal link and a connecting rod connects the first foot actuator to the foot assembly.

6. The legged robot of claim 5, further comprising a compliant element disposed in series with the first foot actuator and the foot assembly.

7. The legged robot of claim 1, wherein the foot assembly further comprises a compliant material disposed on a bottom surface of at least the first foot portion of the foot assembly whereby the compliant material reduces a vertical velocity of the first foot portion as it initially touches the terrain.

8. The legged robot of claim 1, wherein the foot assembly further comprises a material disposed on the bottom surface, the material having a first compliance at the first portion and a second compliance at the second portion, the first compliance being greater than the second compliance.

9. The legged robot of claim 1, wherein the foot assembly further comprises a third foot portion rotatably disposed on the first foot portion with a torsional spring whereby contact of the third foot portion with the terrain activates the torsional spring to reduce a vertical velocity of the first foot portion before it touches the terrain.

10. The legged robot of claim 9, wherein the third foot portion has a lower effective inertia when it initially touches the terrain than the first foot portion when it initially touches the terrain.

11. The legged robot of claim 1, wherein the first foot portion has a lower effective inertia when it initially touches the terrain than the second foot portion when it initially touches the terrain.

12. The legged robot of claim 1, wherein the foot assembly is constructed so that the first foot portion contacts the terrain before the second foot portion when the robot takes a step.

13. The robot of claim 1, wherein the second portion of the foot assembly includes one or more distal surfaces that engage with the terrain.

14. A method of managing forces experienced by a legged robot when taking a step on a terrain comprising:
providing a leg having a distal end and a foot assembly pivotally attached to the distal end, the foot assembly comprising a first foot portion and a second foot portion, the first foot portion having a lower effective inertia than the second foot portion;
controlling the approach of the foot assembly as it nears the terrain during the step, contacting the terrain with the first foot portion;
reducing the vertical velocity relative to the terrain of the second foot portion; and
contacting the terrain with the second foot portion.

15. The method of claim 14, further comprising maintaining rigid contact between the foot assembly and the terrain after the second portion contacts the terrain and through a remaining portion of the step.

16. The method of claim 14, further comprising controlling forces applied to the terrain through one or both of the first foot portion and the second foot portion for the remainder of contact with the terrain.

17. The method of claim 14, wherein the vertical velocity relative to the terrain of the second foot portion is reduced to substantially zero before it makes contact with the terrain.

18. The method of claim 14, further comprising reducing the vertical velocity relative to the terrain of the first foot portion prior to contacting the terrain.

19. The method of claim 18, wherein the foot assembly comprises a third foot portion that reduces the vertical velocity of the first portion.

20. The method of claim 14, wherein the foot assembly further comprises a third foot portion, the method further comprising providing a third foot portion to the foot assembly, the third foot portion having a lower effective inertia than the first portion;
contacting the terrain with the third foot portion prior to the first foot portion; and
reducing a vertical velocity of the first foot portion before it makes contact with the terrain.
